(19) United States
(12) Patent Application Publication
(10) Pub. No.: US 2006/0089448 A1
(43) Pub. Date: Apr. 27, 2006

(54) Over-current protection device

(76) Inventors: Shau Chew Wang, Taipei City (TW); En Tien Yang, Taipei City (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/235,205

(22) Filed: Sep. 27, 2005

(30) Foreign Application Priority Data
Oct. 27, 2004 (TW) 093132523

(51) Int. Cl. C08K 3/04

(52) U.S. Cl. 524/495

(57) ABSTRACT

An over-current protection device of a positive temperature coefficient (PTC) and a conductive polymer thereof are disclosed, which have a superior capability to withstand rigorous environments. The conductive polymer comprises a non-fluorine polyalkene matrix, a conductive filler and a fluorine polymer (e.g., PVDF), wherein the ratio of the fluorine polymer is 1-20% by weight. Laminating a PTC material layer composed of the above-mentioned conductive polymer between a first electrode layer and a second electrode layer forms the over-current protection device of the present invention.

### BACKGROUND OF THE INVENTION

(A) Field of the Invention

The present invention is related to an over-current protection device and the conductive polymer thereof; more specifically, to an over-current protection device of a positive temperature coefficient (PTC) and the conductive polymer thereof.

(B) Description of the Related Art

The resistance of a positive temperature coefficient (PTC) conductive material is sensitive to temperature variation and can be kept extremely low during normal operation so that the circuit can operate normally. However, if an over-current or an over-temperature event occurs, the resistance will immediately increase to a high resistance state (e.g., above 10⁴ ohm). Therefore, the over-current will be eliminated and the objective, to protect the circuit device, will be achieved. Consequently, PTC devices have been commonly integrated into various circuitries so as to prevent the damage caused by over-current.

Generally, the conductive polymer of the PTC device is essentially composed of polymer and conductive fillers. The conductive fillers are evenly distributed in the polymer. The polymer could be polyethylene (PE), and the conductive fillers could be carbon black, metal grains or oxygen-free ceramic powder, e.g., titanium carbide or tungsten carbide.

In practice, the over-current protection device is used under rigorous environments, e.g., installed in an electrical apparatus below the engine cover of a car. The design of such device has to consider longtime exposure to high temperature and moisture environments due to either a continuously running engine or the weather. Therefore, the over-current protection device has to improve its endurance to moisture and temperature variations so as to withstand a rigorous environment.

Low density polyethylene (LDPE) is hydrophilic so that the resistance would increase during longtime use; thus, the applications of LDPE acting as a polymer matrix in a circuit device are limited. The use of high-density polyethylene (HDPE) is a substitute for a polymer matrix. But HDPE is not adequate when LDPE is a must for special applications or more high performances are required.

### SUMMARY OF THE INVENTION

The objective of the present invention is to provide a conductive polymer and an over-current protection device comprising the conductive polymer so as to increase its endurance to humidity and temperature.

To achieve the above-mentioned objective, a conductive polymer exhibiting PTC behavior is disclosed. The conductive polymer comprises a non-fluorine polyalkene matrix, a conductive filler and a fluorine polymer, wherein the ratio of the fluorine polymer is 1-40% by weight, preferably between 1-30%, and most preferably between 1-20%. The conductive filler may be carbon black, the polyalkene matrix may be polyethylene, and the fluorine polymer may be Poly Vinylidene Fluorine (PVDF).

Laminating a PTC material layer composed of the above-mentioned conductive polymer between a first electrode layer and a second electrode layer forms the over-current protection device of the present invention. The volumetric resistivity is between 0.05-100 ohm-cm, preferably between 0.1-50 ohm-cm, and most preferably between 0.2-20 ohm-cm.

The fluorine atoms of the fluorine polymer can form a massive electron cloud outside the fluorine polymer so as to avoid penetration of moisture. Because the fluorine polymer is non-hydrophilic, the phenomenon of aging can be avoided.

In practice, the fluorine polymer is not limited to PVDF; other fluorine polymers with similar characteristics can also be employed.

### BRIEF DESCRIPTION OF THE DRAWINGS

FIG. 1 illustrates an over-current protection device of the present invention;

FIG. 2 illustrates an embodiment of the relationship between resistance and aging experiment time of an over-current protection device in accordance with the present invention;

FIG. 3 illustrates an embodiment of the relationship between multiples of resistance variation and aging experiment time of an over-current protection device in accordance with the present invention;

FIG. 4 illustrates another embodiment of the relationship between resistance and aging experiment time of an over-current protection device in accordance with the present invention; and

FIG. 5 illustrates another embodiment of the relationship between multiples of resistance variation and aging experiment time of an over-current protection device in accordance with the present invention.

### DETAILED DESCRIPTION OF THE INVENTION

The anti-aging performances of the over-current protection device and the conductive polymer thereof are verified by adding different percentages of PVDF. Table 1 illustrates compositions of a number of experiments, wherein carbon black serving as conductive fillers uses model no. RAVEN 430 ULTRA manufactured by Columbian Chemical Company, polyethylene serving as a polyalkene matrix uses model no. PF1140 manufactured by ATOFINA Chemicals, Inc, and PVDF uses model no. KYNAR741 of ATOFINA Chemicals, Inc.

TABLE 1

| | Composition | | |
|---|---|---|---|
| | (% by weight) | | |
| Experiment | Carbon Black | Polyethylene | PVDF |
| A | 56 | 44 | 0 |
| B | 56 | 39.6 | 4.4 |
| C | 56 | 35.2 | 8.8 |

Materials in accordance with Table 1 are mixed in a twin-screw HAAKE blender, where the mixing temperature is 215° C., the pre-mixing time is 1.5 minutes, and the mixing time is 15 minutes.

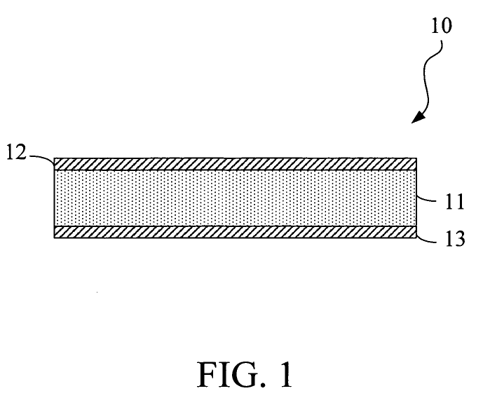

The blended conductive polymer is pressed under 210° C. and 150 kg/cm² to be a laminate of a thickness between 0.24-0.3 mm, and then the laminate is cut into square pieces of 20 cm×20 cm. Two copper foils electroplated with nickel are adhered to the two surfaces of each square piece and then the square piece is punched to form the PTC devices as shown in FIG. 1. The PTC device 10 is 5 mm×12 mm and comprises a PTC material layer 11 composed of the conductive polymer and a first electrode layer 12 and a second electrode layer 13 made of copper foils electroplated with nickel.

The materials of the first and second electrode layers 12 and 13 can be further selected from nickel, copper or the alloys thereof.

Fifteen PTC devices 10 of different compositions are sampled for aging experiments under a temperature of 85° C. and a relative humidity (R. H.) of 85%, and the results are shown as Tables 2 and 3. Table 2 shows the variation of resistance, whereas Table 3 shows multiples of resistance variation before and after aging. The aging experiment is to deposit the PTC device 10 in an aging machine with constant temperature and humidity.

TABLE 2

| | Resistance (ohm) | | | | |
|---|---|---|---|---|---|
| | Aging time (days) | | | | |
| Experiment | 0 | 5 | 11 | 18 | 25 |
| A | 0.0469 | 0.0684 | 0.1155 | 0.3134 | 0.5619 |
| B | 0.0323 | 0.0413 | 0.0605 | 0.1123 | 0.1823 |
| C | 0.0252 | 0.0303 | 0.0393 | 0.0535 | 0.1217 |

TABLE 3

| | Multiples of Resistance Variation | | | | |
|---|---|---|---|---|---|
| | Aging time (days) | | | | |
| Experiment | 0 | 5 | 11 | 18 | 25 |
| A | 1.00 | 1.46 | 2.46 | 6.68 | 11.98 |
| B | 1.00 | 1.28 | 1.87 | 3.48 | 5.64 |
| C | 1.00 | 1.20 | 1.56 | 2.12 | 4.83 |

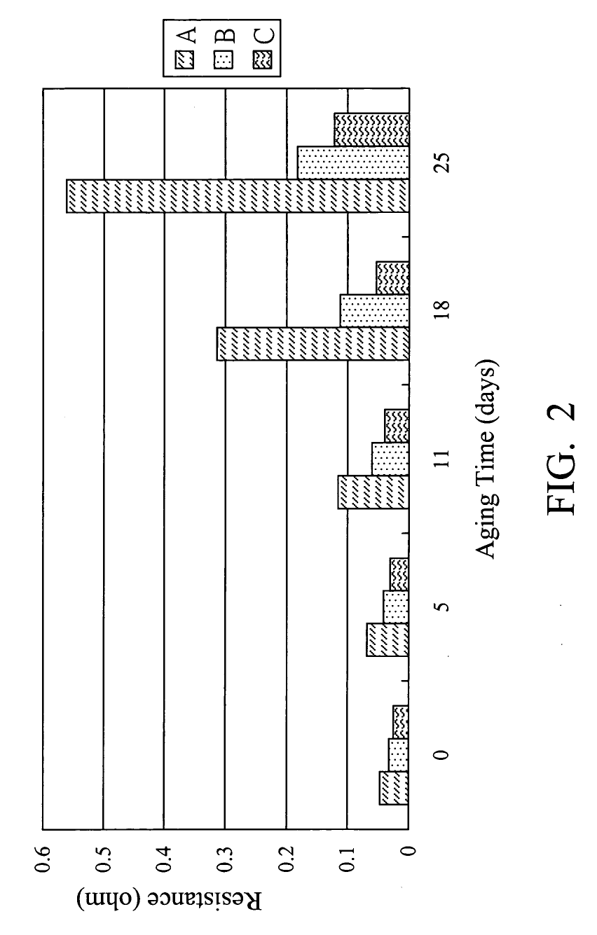

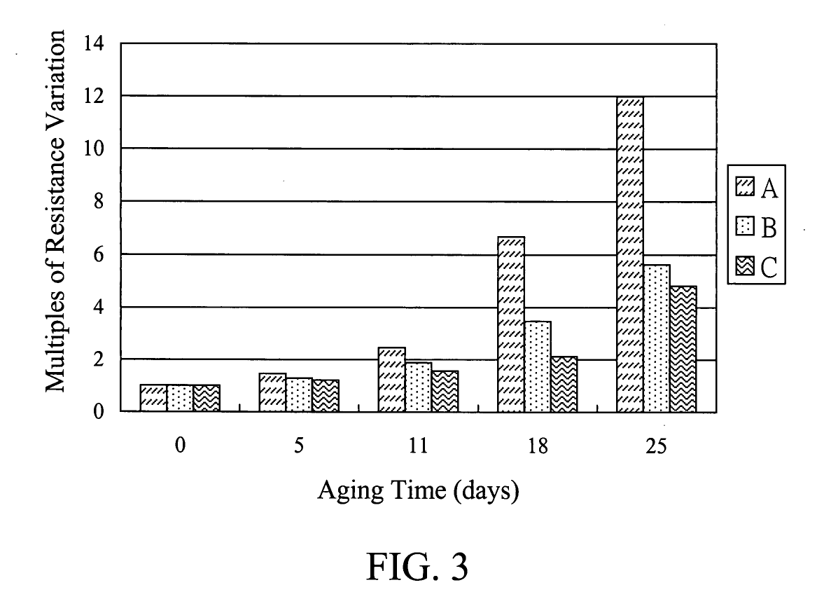

The experiment results of Tables 2 and 3 are plotted as column diagrams as shown in FIGS. 2 and 3. The figures appear to show that the resistance and the multiple of resistance variation approximately increase exponentially, i.e., the longer the aging time is, the higher the increase rate is.

Referring to FIG. 3, in the case of aging 25 days, the resistance of the conductive polymer of Experiment A, i.e., without adding PVDF, becomes around 12-fold the resistance before aging; the resistance of the conductive polymer of Experiment B, i.e., with the addition of 4.4% PVDF by weight, becomes around 5.6-fold the resistance before aging; and the resistance of Experiment C with the addition of 8.8% PVDF by weight becomes around 4.8-fold the resistance before aging. Consequently, the resistance of the conductive polymers after aging experiments with the addition of PVDF are less than 8-fold the initial resistance thereof. Therefore, the PTC device can tremendously reduce the increasing rate of the resistance under the circumstance of high temperature and high humidity by adding PVDF in the conductive polymer.

The ratio of PVDF is preferably less than 20% by weight. If PVDF of a high percentage is used, the characteristic of the conductive polymer may be affected and therefore the increase of the anti-aging performance is not quite obvious. The carbon black serving as conductive fillers is preferably between 35-60% by weight, and the polyethylene serving as the polyaklene matrix is preferably between 20-50% by weight.

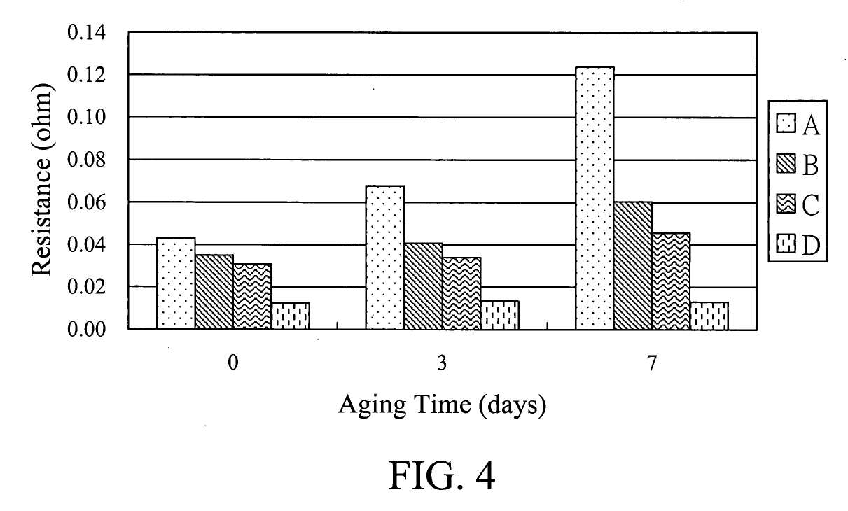

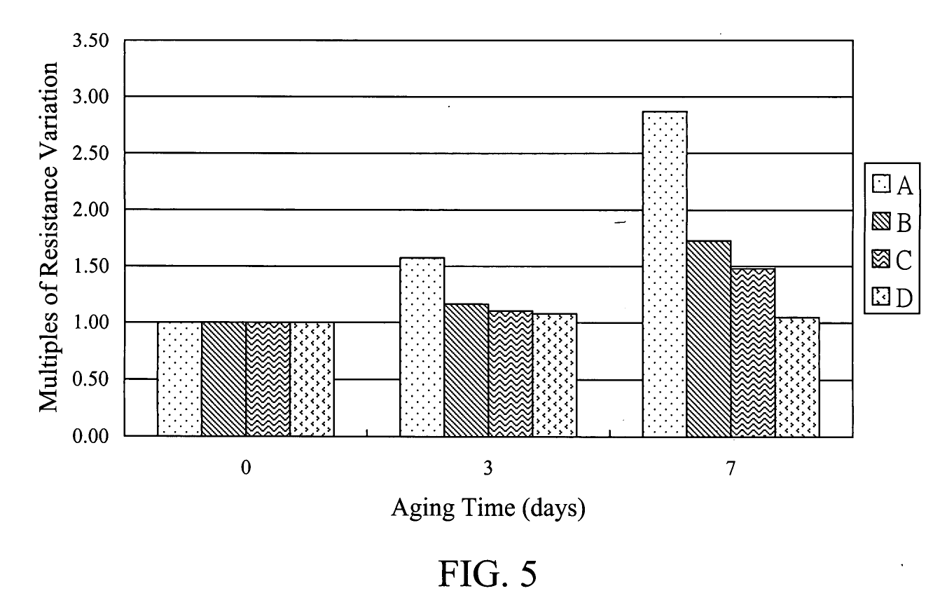

The following tables and figures illustrate the result of another aging experiment. The manufacture of the conductive polymer in this aging experiment is the same as the experiment mentioned above and the experiment procedure is also the same, but the aging time is changed to between 3 and 7 days. As shown in Table 4, the PVDF ratio is between 0-20% in an attempt to obviously verify the effects of different adding percentages. Table 5 shows the resistance after aging, and the results are also plotted as FIG. 4. Table 6 shows multiples of resistance variation after aging; the relevant figure is shown as FIG. 5.

TABLE 4

| | Composition | | |
|---|---|---|---|
| | (% by weight) | | |
| Experiments | Carbon Black | Polyethylene | PVDF |
| A | 56 | 44 | 0 |
| B | 56 | 43 | 1 |
| C | 56 | 42 | 2 |
| D | 56 | 22 | 20 |

TABLE 5

| | Resistance (ohm) | | |
|---|---|---|---|
| | Aging time (days) | | |
| Experiment | 0 | 3 | 7 |
| A | 0.0431 | 0.0678 | 0.1238 |
| B | 0.0350 | 0.0408 | 0.0604 |
| C | 0.0308 | 0.0340 | 0.0456 |
| D | 0.0125 | 0.0135 | 0.0131 |

TABLE 6

| | Multiples of | | |
|---|---|---|---|
| | Resistance Variation | | |
| | Aging time (days) | | |
| Experiment | 0 | 3 | 7 |
| A | 1.00 | 1.57 | 2.87 |
| B | 1.00 | 1.17 | 1.73 |
| C | 1.00 | 1.10 | 1.48 |
| D | 1.00 | 1.08 | 1.05 |

As shown in FIG. 5, even if only 1% PVDF is added, the resistance of the polyalkene matrix after the aging experiment can be significantly reduced, and 20% addition of PVDF can obtain an optimal result.

The above-described embodiments of the present invention are intended to be illustrative only. Numerous alternative embodiments may be devised by those skilled in the art without departing from the scope of the following claims.

What is claimed is:

1. A conductive polymer of a positive temperature coefficient (PTC), comprising:
a non-fluorine polyalkene matrix;
a conductive filler; and
a fluorine polymer;
wherein the ratio of the fluorine polymer is between 1-40% by weight.

2. The conductive polymer of claim 1, wherein the fluorine polymer is Poly Vinylidene Fluorine (PVDF).

3. The conductive polymer of claim 1, wherein the non-fluorine polyalkene matrix is polyethylene.

4. The conductive polymer of claim 1, wherein the ratio of the non-fluorine polyalkene matrix is between 20-50% by weight.

5. The conductive polymer of claim 1, wherein the conductive filler is carbon black.

6. The conductive polymer of claim 1, wherein the ratio of the conductive filler is 35-60% by weight.

7. An over-current protection device, comprising:
a first electrode layer;
a second electrode layer; and
a PTC material layer comprising the conductive polymer of claim 1 and being laminated between the first electrode layer and the second electrode layer.

8. The over-current protection device of claim 7, wherein the first and second electrode layers are made of nickel, copper, nickel-copper alloy or copper foil electroplated with nickel.

9. The over-current protection device of claim 7; the resistance thereof is less than 8-fold the initial resistance after exposure in a temperature of 85° C. and a relative humidity of 85% for 25 days.

10. The over-current protection device of claim 7; the volumetric resistivity is between 0.2-20 ohm-cm.
